(19) United States
(12) Patent Application Publication
(10) Pub. No.: US 2018/0172096 A1
(43) Pub. Date: Jun. 21, 2018

(54) PISTON AND DISC BRAKE USING SAME

(71) Applicant: Hitachi Automotive Systems, Ltd., Ibaraki (JP)

(72) Inventors: Sadatomo MATSUMURA, Isehara-shi (JP); Hayuru INOUE, Ayase-shi (JP)

(21) Appl. No.: 15/735,967

(22) PCT Filed: May 18, 2016
(86) PCT No.: PCT/JP2016/064770

§ 371 Date: Dec. 13, 2017

(30) Foreign Application Priority Data
Jun. 16, 2015 (JP) 2015-121130

(51) Int. Cl. F16D 65/18; F16D 55/02; F16D 65/02

(52) U.S. Cl. CPC F16D 65/18; F16D 2121/14; F16D 65/02; F16D 55/02

(57) ABSTRACT

A disc brake piston includes a tubular wall section (52) having an opening section (51) at one end in an axial direction, and a bottom section (53) configured to close the other end of the wall section (52) in the axial direction. The bottom section (53) includes a first annular region (71) provided on an inner side of the wall section (52) in a radial direction to be continuous with the wall section (52); and a second region (72) provided on the inner side of the first region (71) in the radial direction and formed in a recessed shape in the axial direction. The second region (72) has a variable thickness region (103) in which a thickness in the axial direction becomes thinner toward the inner side in the radial direction.

### TECHNICAL FIELD

The present invention relates to a piston and a disc brake using the same.

Priority is claimed on Japanese Patent Application No. 2015-121130, filed Jun. 16, 2015, the content of which is incorporated herein by reference.

### BACKGROUND ART

As a disc brake piston, there is a piston which includes an outer member and an inner member, and has a protruding shape in which a center of a bottom portion of the members protrudes outward (see, for example, Patent Literature 1).

### CITATION LIST

### Patent Literature

### [Patent Literature 1]

Japanese Unexamined Patent Application, First Publication No. H10-122280

### SUMMARY OF INVENTION

### Technical Problem

Although the bottom portion of the piston has a shape with high strength against a load (brake fluid pressure) from the outside, there is a possibility of an increase in weight.

The present invention provides a high-strength piston and a disc brake using the same, in which a weight increase is suppressed.

### Solution to Problem

According to a first aspect of the present invention, a bottom portion of a piston includes a first annular region which is provided on an inner side of a wall section in a radial direction to be continuous with the wall section, and a second region which is provided on the inner side of the first region in the radial direction and has a recessed shape in the axial direction. The second region has a variable thickness region in which a thickness in an axial direction becomes thinner toward an inner side in the radial direction.

### Advantageous Effects of Invention

According to the aforementioned piston and the disc brake using the same, it is possible to achieve high strength while suppressing a weight increase.

### BRIEF DESCRIPTION OF DRAWINGS

FIG. 1 is a cross-sectional view illustrating a disc brake using a piston of a first embodiment.

FIG. 2 is a cross-sectional view of the piston of the first embodiment.

FIG. 3 is a partially enlarged cross-sectional view of the piston of the first embodiment.

FIG. 4A is a stress distribution diagram of the piston of the first embodiment.

FIG. 4B is a stress distribution diagram of another piston.

FIG. 5 is a cross-sectional view of a piston of a second embodiment.

FIG. 6 is a cross-sectional view of a piston of a third embodiment.

FIG. 7 is a cross-sectional view of a piston of a fourth embodiment.

### DESCRIPTION OF EMBODIMENTS

### First Embodiment

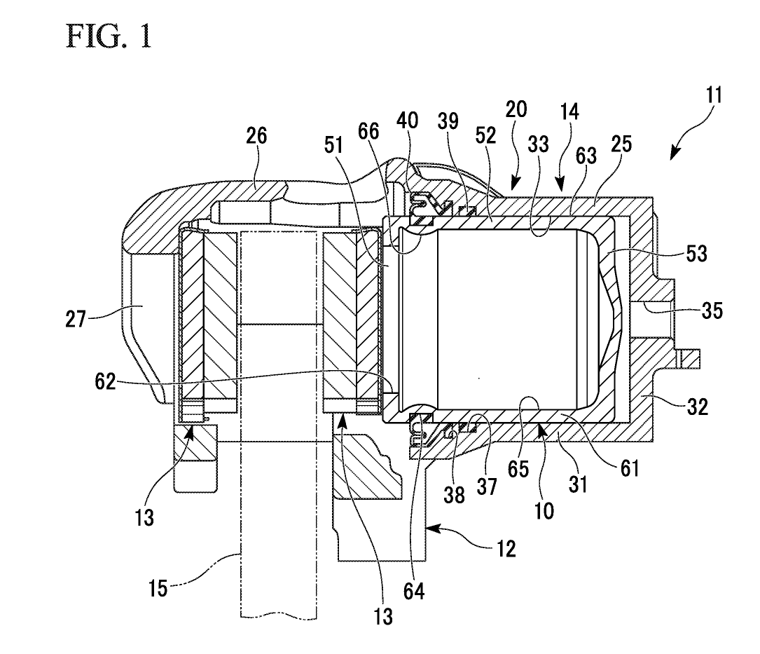

The first embodiment will be described below with reference to FIGS. 1 to 4B. FIG. 1 illustrates a disc brake 11 using a piston 10 according to the first embodiment. The disc brake 11 is for a vehicle such as an automobile, specifically, for a four-wheel automobile, and includes a carrier 12, a pair of brake pads 13, and a caliper 14. The disc brake 11 stops the rotation of a disc 15 rotating together with wheels (not illustrated) to be braked to brake the vehicle.

The carrier 12 is disposed to straddle an outer diameter side of the disc 15 and fixed to a non-rotating portion of the vehicle. The pair of brake pads 13 is supported on the carrier 12 to be slidable in an axial direction of the disc 15 in a state in which it is disposed to face both surfaces of the disc 15. The caliper 14 is supported on the carrier 12 to be slidable in the axial direction of the disc 15, while straddling the outer diameter side of the disc 15.

The caliper 14 stops the rotation of the disc 15 by pressing the pair of brake pads 13 against the disc 15. The caliper 14 has a caliper body 20 supported by the carrier 12 in the state in which it straddles the disc 15, and a piston 10 of the first embodiment which is held in the caliper body 20 and is disposed to face one surface side of the disc 15.

The caliper body 20 is integrally formed to have a cylinder 25, a bridge section 26, and a claw portion 27.

The cylinder 25 is disposed to face the surface on the inner side (an inner side in a vehicle width direction) of the disc 15 in the axial direction. The cylinder 25 is formed in a bottomed tubular shape which has a tubular cylinder wall section 31 opening to the disc 15 side, and a cylinder bottom portion 32 closing a side of the cylinder wall section 31 opposite to the disc 15.

The inner sides of the cylinder wall section 31 and the cylinder bottom portion 32 of the cylinder 25 serve as an accommodating hole 33. The accommodating hole 33 opens to the disc 15 side and extends in the axial direction of the disc 15. The piston 10 is inserted into the accommodating hole 33 to be slidable. The bridge section 26 is formed to extend from the cylinder 25 in the axial direction of the disc 15 to straddle the disc 15. The claw portion 27 extends from the side of the bridge section 26 opposite to the cylinder 25 to face the cylinder 25, and is disposed to face the surface of the outer side (outer side in the vehicle width direction) of the disc 15.

On the cylinder bottom portion 32, a pipe connection hole 35 connected to a brake pipe (not illustrated) is formed on a central axis of the accommodating hole 33. The caliper 14 advances the piston 10 toward the disc 15 by the brake fluid pressure introduced into the accommodating hole 33 via the pipe connection hole 35, and presses the inner brake pad 13 with the piston 10 to come into contact with the disc 15. Further, the caliper 14 slides in a direction in which the cylinder 25 separates from the disc 15 with respect to the carrier 12 by the pressing reaction force of the piston 10, and presses the brake pad 13 on the outer side with the claw portion 27 to come into contact with the disc 15. In this way, the brake pads 13 on both sides are sandwiched by the piston 10 and the claw portion 27 and pressed against the disc 15 to generate frictional resistance, thereby generating a braking force.

An annular seal groove 37 recessed outward in the radial direction is formed at an intermediate position on the opening side in the axial direction of the inner circumferential surface of the cylinder wall section 31 which forms the accommodating hole 33. An annular boot groove 38 recessed outward in the radial direction is formed on a side of the inner circumferential surface of the cylinder wall section 31 closer to the opening than the seal groove 37. An annular piston seal 39 for sealing a gap between the seal groove 37 and the piston 10 is fitted to the seal groove 37. One end of an annular boot 40 interposed between the cylinder wall section 31 and the piston 10 is fitted to the opening side of the cylinder wall section 31.

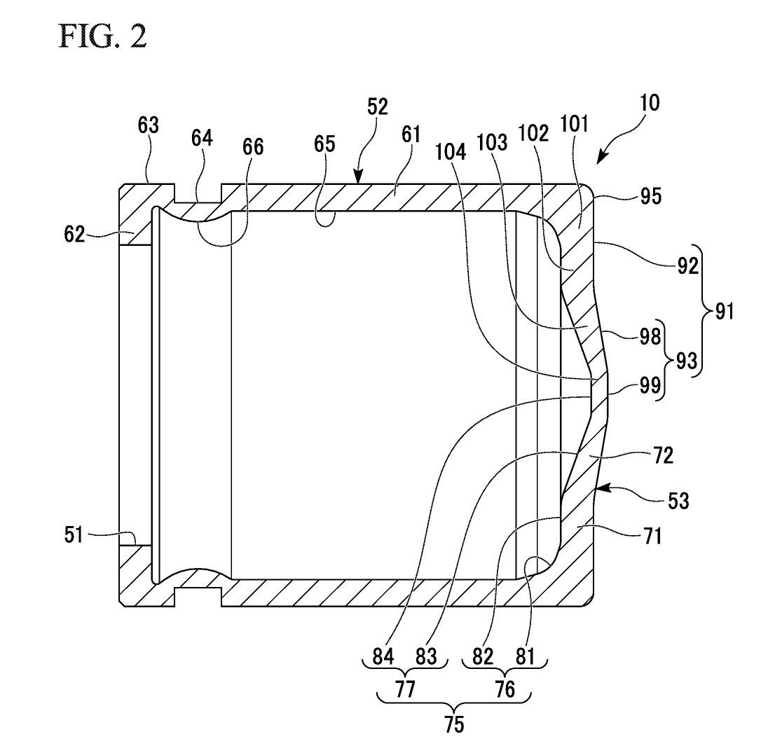

Hereinafter, the piston 10 of the first embodiment will be described. As illustrated in FIG. 2, the piston 10 is formed in a bottomed cylindrical shape which has a tubular piston wall section 52 (wall section) having an opening section 51 at one end in the axial direction, and a piston bottom section 53 (bottom section) for closing the other end of the piston wall section 52 in the axial direction

The piston wall section 52 has a wall main body portion 61, and an inner flange section 62 extending inward in the radial direction from the entire circumference at the end of the wall main body portion 61 opposite to the piston bottom section 53. The inner side of the inner flange section 62 in the radial direction is an opening section 51. On the wall main body portion 61, a boot groove 64 recessed inward in the radial direction from the cylindrical outer circumferential main surface 63 is formed on the side of the opening section 51 in the axial direction. A bulging section 66 bulging radially inward from the cylindrical inner circumferential main surface 65 is formed in the wall main body portion 61 to match the position in the axial direction with the boot groove 64. The boot groove 64 is formed by pressing the cylindrical outer circumferential main surface 63 of the wall main body portion 61 inward in the radial direction to plastically deform the wall main body portion 61, and the excessive wall thickness generated at that time is the bulging section 66.

The piston bottom section 53 has an annular first region 71 provided on the inner side of the piston wall section 52 in the radial direction to be continuous with the piston wall section 52, and a circular second region 72 which spreads over the entire inner side of the first region 71 in the radial direction to be continuous with the first region 71 at the inner side of the first region 71 in the radial direction.

The inner bottom surface 75 of the piston bottom section 53 on the opening section 51 side in the axial direction is formed by an inner bottom surface section 76 provided in the first region 71, and an inner bottom surface section 77 provided in the second region 72. The inner bottom surface section 76 provided in the first region 71 has a radially outer annular surface section 81, and a radially inner annular surface section 82. The surface section 81 extends from the end edge portion on the side of the cylindrical inner circumferential main surface 65 of the wall main body portion 61 opposite to the opening section 51, while its diameter is reduced away from the opening section 51. The surface section 82 extends inward in the radial direction from the inner circumferential edge portion on the side of the surface section 81 opposite to the opening section 51. The surface section 82 is a plane orthogonal to a central axis line of the piston 10.

The inner bottom surface section 77 provided in the second region 72 has a radially outer annular surface section 83, and a radially inner circular surface section 84. The surface section 83 is a tapered surface that extends inward in the radial direction from the inner circumferential edge portion on the radially inner side of the surface section 82 of the inner bottom surface section 76 to be separated from the opening section 51 in the axial direction as it goes toward the inner side in the radial direction, and the surface section 84 spreads over the entire inner side of the surface section 83 in the radial direction to be continuous with the inner circumferential edge portion of the surface section 83. The surface section 84 is a flat surface orthogonal to the central axis line of the piston 10.

The outer bottom surface 91 of the piston bottom section 53 on the side opposite to the opening section 51 in the axial direction is formed by an outer bottom surface section 92 provided in the first region 71, and an outer bottom surface section 93 provided in the second region 72. The outer bottom surface section 92 provided in the first region 71 is a plane orthogonal to the central axis of the piston, and is disposed on the same plane as the surface 95 on the side opposite to the opening section 51 in the axial direction of the piston wall section 52.

The outer bottom surface section 93 provided in the second region 72 has a surface section 98 on the radially outer side, and a surface section 99 on the radially inner side. The surface section 98 is a tapered surface extending inward in the radial direction from the inner circumferential edge portion on the radially inner side of the outer bottom surface section 92 to be separated from the opening section 51 in the axial direction as it goes toward the inner side in the radial direction, and a surface section 99 spreads over the entire inner side of the surface section 98 in the radial direction to be continuous with the inner circumferential edge portion of the surface section 98. The surface section 99 is a flat surface orthogonal to the central axis line of the piston 10.

The outer bottom surface section 92 provided in the first region 71 overlaps the surface section 81 of the inner bottom surface section 76 provided in the first region 71 at the position in the radial direction. The outer bottom surface section 92 is a flat surface orthogonal to the central axis line of the piston 10, and the surface section 81 has a shape in which the diameter decreases as the surface section 81 is separated from the opening section 51. Therefore, a portion between the outer bottom surface section 92 and the surface section 81 has a thickness in the axial direction that is thinner toward the inner side in the radial direction. The portion between the outer bottom surface section 92 and the surface section 81 is a first variable thickness region 101 which is provided in the first region 71 and has a thickness in the axial direction that is thinner toward the inner side in the radial direction.

The outer bottom surface section 92 provided in the first region 71 also overlaps the surface section 82 of the inner bottom surface section 76 provided in the first region 71 at the position in the radial direction. The outer bottom surface section 92 is a flat surface orthogonal to the central axis line of the piston 10, and the surface section 82 is also a flat surface orthogonal to the central axis line of the piston 10. Therefore, the portion between the outer bottom surface section 92 and the surface section 82 has the thickness in the axial direction that is constant irrespective of the position in the radial direction. The portion between the outer bottom surface section 92 and the surface section 82 is a first constant-thickness region 102 (constant-thickness region) which is provided in the first region 71 and in which the thickness in the axial direction is constant irrespective of the position in the radial direction.

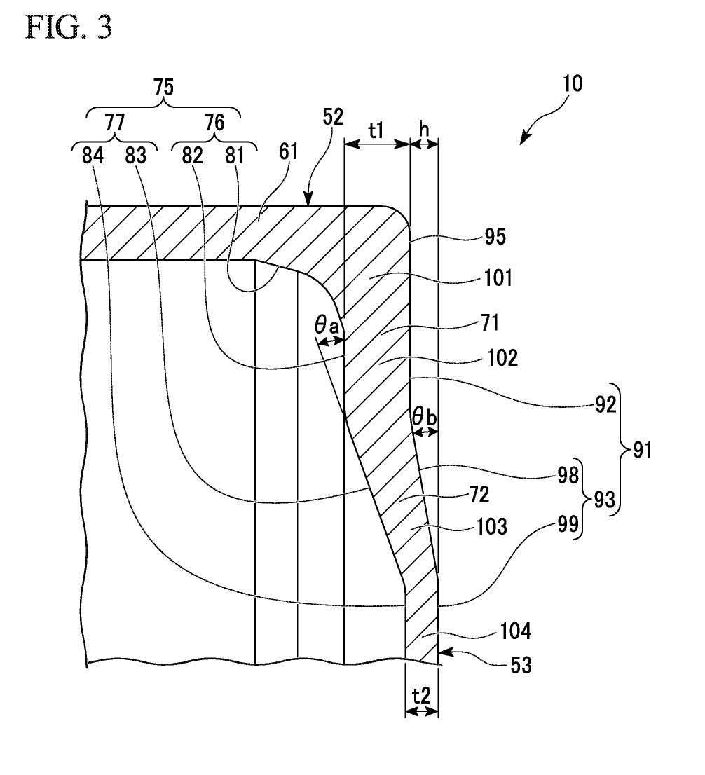

The surface section 83 of the inner bottom surface section 77 provided in the second region 72 overlaps the surface section 98 of the outer bottom surface section 93 provided in the second region 72 at the position in the radial direction. The surface section 83 is a tapered surface that separates from the opening section 51 in the axial direction as it goes toward the inner side in the radial direction. The surface section 98 is also a tapered surface that separates from the opening section 51 in the axial direction as it goes toward the inner side in the radial direction. As illustrated in FIG. 3, an angle θa formed between the surface section 82, which is a surface orthogonal to the central axis of the piston 10, and an extended line of the surface section 83 is greater than an angle θb formed between an extended line of the surface section 99, which is a surface orthogonal to the central axis of the piston 10, and the surface section 98. In other words, a taper ratio of the surface section 83 (ratio obtained by dividing a diameter difference by the distance in the axial direction) is smaller than a taper ratio of the surface section 98. Therefore, in the portion between the surface section 83 and the surface section 98, the thickness in the axial direction becomes thinner toward the inner side in the radial direction. A portion between the surface section 83 and the surface section 98 is a second variable thickness region 103 (variable thickness region) which is provided in the second region 72 and in which the thickness in the axial direction becomes thinner toward the inner side in the radial direction.

The surface section 84 of the inner bottom surface section 77 provided in the second region 72 overlaps the surface section 99 of the outer bottom surface section 93 provided in the second region 72 at the position in the radial direction. The surface section 84 is a flat surface orthogonal to the central axis line of the piston 10, and the surface section 99 is also a flat surface orthogonal to the central axis line of the piston 10. Therefore, a portion between the surface section 84 and the surface section 99 has a thickness in the axial direction which is constant regardless of the position in the radial direction. The portion between the surface section 84 and the surface section 99 is a second constant-thickness region 104 (third region) which is provided in the second region 72 and in which the thickness in the axial direction is constant regardless of the position in the radial position. The second constant-thickness region 104 is a part on the inner side of the second region 72 in the radial direction.

As illustrated in FIG. 3, in the first constant-thickness region 102 and the second constant-thickness region 104, which are disposed via the second variable thickness region 103 in which the thickness in the axial direction becomes thinner toward the inner side in the radial direction, a thickness t2 of the second constant-thickness region 104 in the axial direction is thinner than a thickness t1 of the first constant-thickness region 102 in the axial direction.

As illustrated in FIG. 2, in the inner bottom surface section 77 of the second region 72, the surface section 83 on the radially outer side is a tapered surface that separates from the opening section 51 in the axial direction as it goes toward the inner side in the radial direction. The surface section 84 on the radially inner side is a flat surface orthogonal to the central axis of the piston 10. As a result, in the second region 72, the inner bottom surface section 77 side facing the opening section 51 has a recessed shape in the axial direction.

In the outer bottom surface section 93 of the second region 72, the surface section 98 on the radially outer side is a tapered surface that separates from the opening section 51 in the axial direction as it goes toward the inner side in the radial direction. The surface section 99 on the radially inner side is a flat surface orthogonal to the central axis line of the piston 10. As a result, the second region 72 is formed in a protruding shape in which the outer bottom surface section 93 side facing in the direction opposite to the opening section 51 protrudes in the axial direction by a protrusion amount h illustrated in FIG. 3. The second variable thickness region 103 in which the thickness in the axial direction becomes thinner toward the inner side in the radial direction is capable of increasing the angle θa formed between the surface section 83 and the surface orthogonal to the central axis of the piston 10, while suppressing an increase in the protrusion amount h.

As illustrated in FIG. 1, the piston 10 is inserted into the accommodating hole 33 in the cylinder wall section 31 with the piston bottom section 53 at the head. Thus, the piston bottom section 53 of the piston 10 is close to the cylinder bottom portion 32, and the opening section 51 is disposed on the side opposite to the cylinder bottom portion 32. At this time, the piston 10 is fitted to a piston seal 39 disposed in a seal groove 37 of the cylinder wall section 31, and is supported by the piston seal 39 and the inner circumferential surface of the cylinder wall section 31. Further, the other end of the boot 40 is fitted into the boot groove 64 of the piston 10.

The disc brake piston described in Patent Literature 1 includes an outer member and an inner member, the bottom sections thereof have a protruding shape which is smoothly curved and protrudes to be located on the outer side in the axial direction as it goes toward the central side, and the bottom sections have a shape with high strength against the load (brake fluid pressure) from the outside. However, since the disc brake piston includes the outer member and the inner member, there is a possibility of an increase in weight. Further, since the disc brake piston includes the outer member and the inner member, the cost increases and manufacturing becomes complicated.

In contrast, in the piston 10 of the first embodiment, the piston bottom section 53 has an annular first region 71 provided on the inner side of the piston wall section 52 in the radial direction to be continuous with the piston wall section 52, and a second region 72 which is provided on the inner side of the first region 71 in the radial direction and in which the inner side in the axial direction is formed in a recessed shape and the outer side in the axial direction is formed in a protruding shape. Therefore, the piston 10 has a high-strength shape capable of reducing the stress against the load (brake fluid pressure) from the outside. In addition, since the second region 72 has the second variable thickness region 103 in which the thickness in the axial direction becomes thinner toward the inner side in the radial direction, the central side becomes thinner, and it is possible to suppress a weight increase. In addition, since the piston 10 is formed of one part, it is possible to suppress an increase in cost, and manufacturing is also easy.

The second variable thickness region 103, in which the thickness in the axial direction becomes thinner toward the inner side in the radial direction, is capable of increasing an angle θa formed between the surface section 83 and the surface orthogonal to the central axis of the piston 10, while suppressing an increase in the protrusion amount h of the second region 72. Therefore, in particular, it is possible to reduce the stress on the inner bottom surface 75 side of the piston bottom section 53.

The first region 71 has a first constant-thickness region 102 in which the thickness in the axial direction is constant irrespective of the position in the radial direction, and the second region 72 also has a second constant-thickness region 104 in which the thickness in the axial direction is constant irrespective of the position in the radial direction. Therefore, it is possible to further suppress the weight increase of the piston bottom section 53.

Further, since the weight increase of the piston bottom section 53 can be suppressed, the overall mass of the piston 10 also decreases, the natural frequency increases, and the brake noise suppression effect increases.

Further, since the weight increase of the piston bottom section 53 can be suppressed among the piston wall section 52 and the piston bottom section 53, the position of the center of gravity of the piston 10 can be brought close to the opening section 51 and can approach the piston seal 39. Therefore, the position of the center of gravity of the piston 10 is brought close to the piston seal 39, which is the main support position of the piston 10, and the brake noise suppression effect is enhanced.

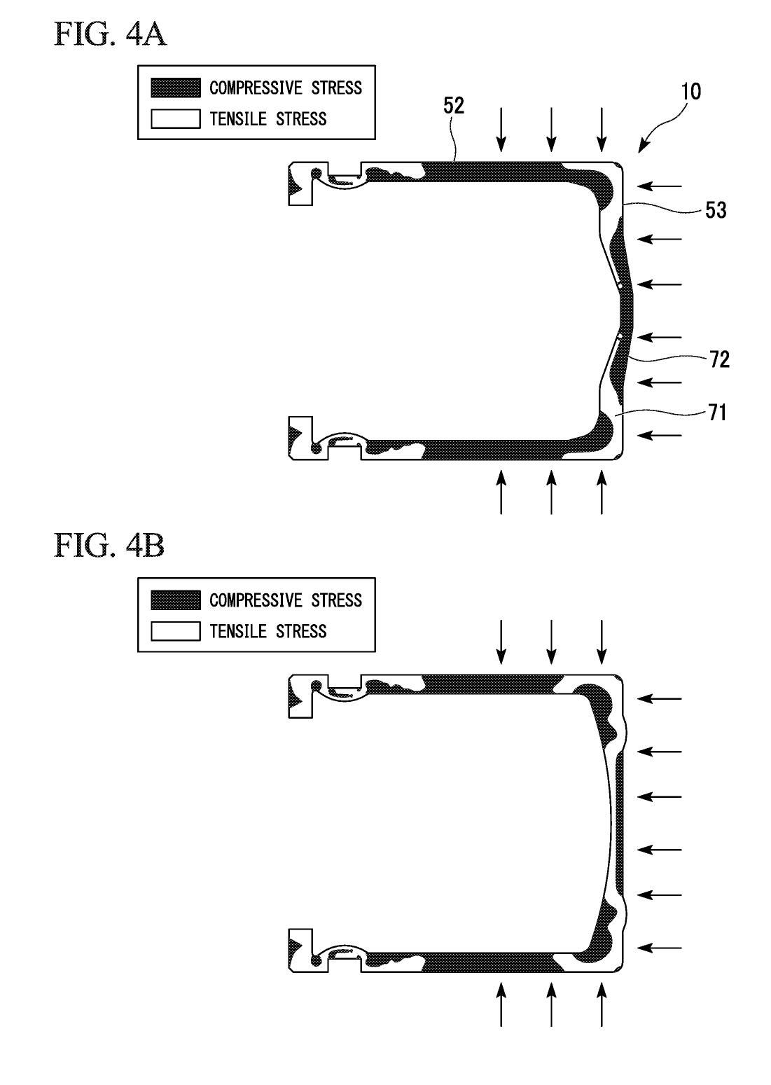

Here, when the brake fluid is introduced into the cylinder 25 illustrated in FIG. 1 from the pipe connection hole 35, the brake fluid pressure as indicated by the arrow in FIG. 4A is applied to the piston wall section 52 and the piston bottom section 53 of the piston 10. FIG. 4A illustrates a simulation result of the stress distribution of the piston 10 when such a brake fluid pressure is applied. A portion illustrated in black in FIG. 4A indicates a range in which a compressive stress is generated, and a portion illustrated in white in FIG. 4A indicates a range in which a tensile stress occurs. In the piston 10 of the first embodiment illustrated in FIG. 4A, as compared with another piston illustrated in FIG. 4B, in particular, the stress distribution of the second region 72 of the piston bottom section 53 is mainly a compressive stress rather than a tensile stress. Therefore, it is possible to understand that the piston 10 of the first embodiment has a high-strength shape against the brake fluid pressure.

In the disc brake 11 including the piston 10, the reliability is improved by high strength of the piston 10, and the cost reduction of the piston 10 leads to a reduction in the overall cost, and the weight reduction of the piston 10 leads to a reduction in overall weight.

### Second Embodiment

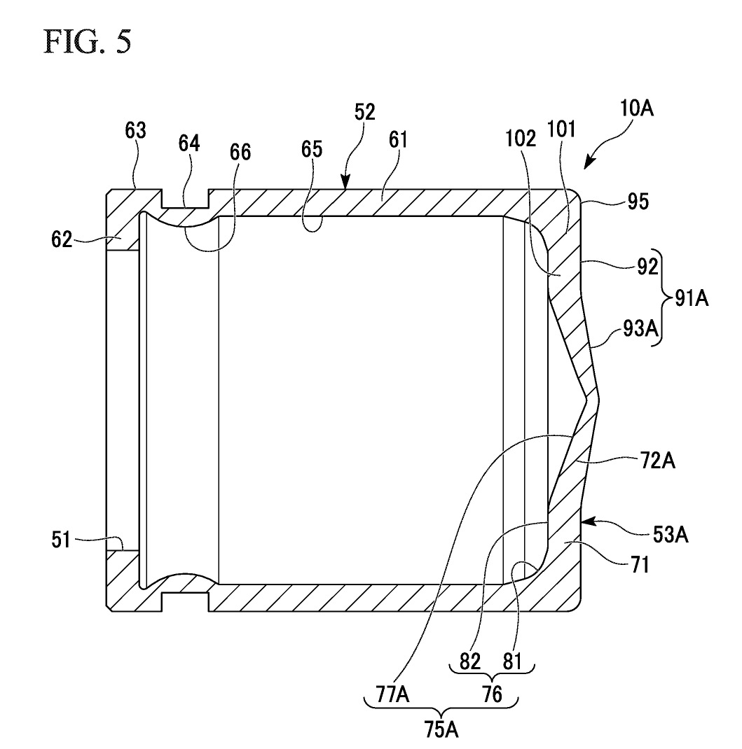

The second embodiment will be described mainly with reference to FIG. 5, focusing on differences from the first embodiment. The parts common to the first embodiment are denoted by the same names and the same reference numerals.

In a piston 10A of the second embodiment, a piston bottom section 53A has a first region 71 similar to the first embodiment, and a second region 72A having a shape that is partially different from the second region 72 of the first embodiment spreading over the entire inner side in the radial direction. In the second region 72A, the second constant-thickness region 104, and the surface section 84 and the surface section 99 on both sides thereof of the first embodiment are not provided. Further, the second region 72A has a shape in which the second variable thickness region 103 of the first embodiment is extended to the central axis of the piston 10A in a conical shape. That is, the second region 72A is a variable thickness region in which the thickness in the axial direction becomes thinner as a whole toward the inner side in the radial direction.

The second region 72A has an inner bottom surface section 77A having a shape in which the surface section 83 of the first embodiment extends to the central axis line of the piston 10A in a conical shape, and an outer bottom surface section 93A having a shape in which the surface section 98 of the first embodiment extends to the central axis line of the piston 10A in a conical shape. In other words, the inner bottom surface section 77A spreads over the entire inner side of the surface section 82 in the radial direction to be continuous with the inner circumferential edge portion of the surface section 82 of the inner bottom surface section 76. The outer bottom surface section 93A spreads over the entire inner side of the outer bottom surface section 92 in the radial direction to be continuous with the inner circumferential edge portion of the outer bottom surface section 92. Therefore, the piston bottom section 53A has an inner bottom surface 75A formed by the inner bottom surface section 76 and the inner bottom surface section 77A, and an outer bottom surface 91A formed by the outer bottom surface section 92 and the outer bottom surface section 93A. The second region 72A includes an inner bottom surface section 77A and an outer bottom surface section 93A which are conical surfaces in which apexes are disposed on the central axis line of the piston bottom section 53A.

The same effects as those of the first embodiment can also be obtained in the second embodiment.

### Third Embodiment

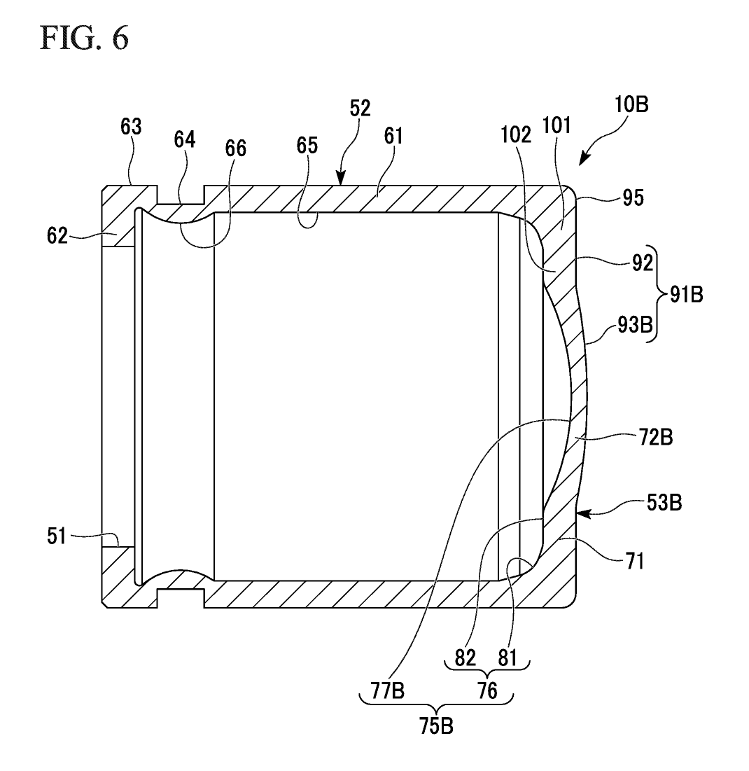

The third embodiment will be described mainly with reference to FIG. 6, focusing on differences from the first embodiment. The parts common to the first embodiment are denoted by the same names and the same reference numerals.

In a piston 10B of the third embodiment, a piston bottom section 53B has a first region 71 having a shape similar to that of the first embodiment, and a second region 72B having a shape different from the second region 72 of the first embodiment spreading over the entire inner side in the radial direction. The second region 72B includes an inner bottom surface section 77B which spreads over the entire inner side of the surface section 82 in the radial direction to be continuous with the inner circumferential edge portion of the surface section 82 of the inner bottom surface section 76, and an outer bottom surface section 93B which spreads over the entire inner side of the outer circumferential surface section 92 in the radial direction to be continuous with the inner circumferential edge portion of the outer bottom surface section 92.

Both the inner bottom surface section 77B and the outer bottom surface section 93B are spherical surfaces centered on the central axis of the piston 10B and the piston bottom section 53B, and a spherical diameter of the inner bottom surface section 77B is smaller than a spherical diameter of the outer bottom surface section 93B. As a result, the second region 72B between the inner bottom surface section 77B and the outer bottom surface section 93B is a variable thickness region in which the entire axial thickness becomes thinner toward the inner side in the radial direction. Therefore, the piston bottom section 53B has an inner bottom surface 75B including an inner bottom surface section 76 and an inner bottom surface section 77B, and an outer bottom surface 91B including an outer bottom surface section 92 and an outer bottom surface section 93B.

The same effects as those of the first embodiment are also obtained in the third embodiment.

### Fourth Embodiment

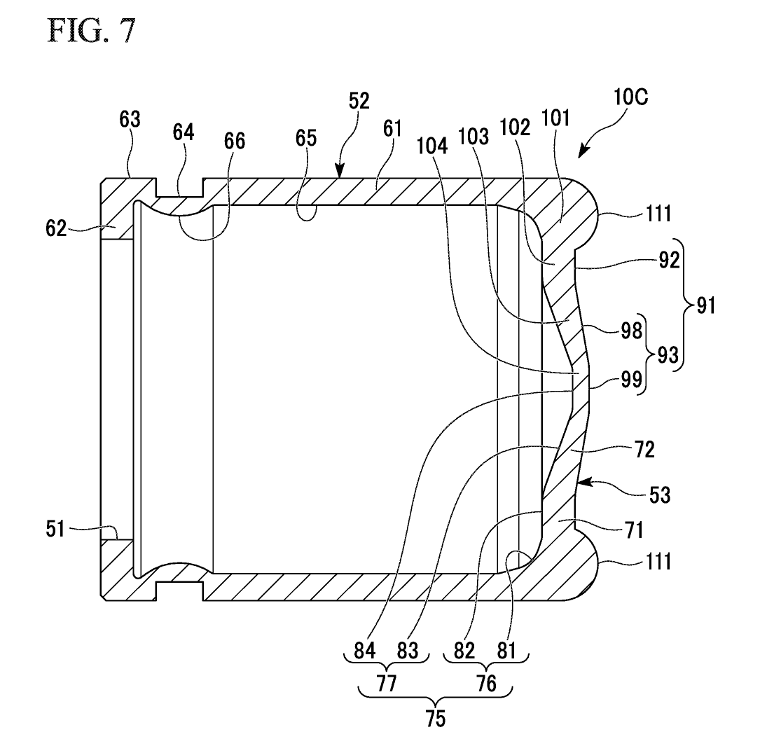

The fourth embodiment will be described mainly with reference to FIG. 7, focusing on differences from the first embodiment. The parts common to the first embodiment are denoted by the same names and the same reference numerals.

In a piston 10C of the fourth embodiment, at a boundary position between the piston wall section 52 and the piston bottom section 53, a plurality of protruding portions 111 are formed at intervals in the circumferential direction of the piston 10C. The protruding portions 111 protrude to an opposite side to the opening section 51 in the axial direction from the outer bottom surface section 92 of the piston bottom section 53. The protruding portions 111 protrude in spherical shapes and have tapered shapes. The protrusion height of the protruding portions 111 from the outer bottom surface section 92 is higher than the height from the outer bottom surface section 92 to the surface section 99. Accordingly, when the piston 10C is disposed in the cylinder 25 of the caliper 14 illustrated in FIG. 1, the piston 10C regulates the surface section 99 to block the pipe connection hole 35. As a result, when the brake fluid is filled between the caliper 14 and the piston 10C by vacuuming, the piston 10C can prevent hindrance of the flow of the brake fluid from the pipe connection hole 35, and brake fluid can be stably supplied. Such a protruding portion 111 may be provided in the pistons of the first to third embodiments. Further, the position of the pipe connection hole 35 is not limited to the first position, and may be at a position deviated from the center of the piston. Furthermore, the position of the protruding portion 111 can be set at any position on the outer bottom surface 91 as long as there is a position at which it is possible to regulate the piston bottom section 53 to block the pipe connection hole 35, and its shape can also be arbitrarily set.

In a piston based on the above-described embodiments, for example, the aspects described below can be considered. In a first aspect of the piston, a disc brake piston having a tubular wall section having an opening section at one end in an axial direction and a bottom section closing the other end of the wall section in the axial direction is provided, wherein the bottom section includes a first annular region provided on an inner side of the wall section in a radial direction to be continuous with the wall section, and a second region provided on the inner side of the first region in the radial direction and formed in a recessed shape in the axial direction, and the second region has a variable thickness region in which a thickness in the axial direction becomes thinner toward the inner side in the radial direction. Therefore, since the second region formed in the recessed shape in the axial direction is provided, a shape with high strength against the load from the outside is provided. In addition, since the second region has a variable thickness region in which the thickness in the axial direction becomes thinner toward the inner side in the radial direction, weight increase can be suppressed.

Further, according to a second aspect, in the first aspect, the first region may have a constant-thickness region in which the thickness in the axial direction is constant irrespective of the position in the radial direction. According to the second aspect, the weight increase of the piston can be suppressed.

According to a third aspect, in any one of the first aspect and the second aspect, the second region may include a third region on the radially inner side in which the thickness in the axial direction is constant irrespective of the position in the radial direction.

According to a fourth aspect of the present invention, in any one of the first aspect and the second aspect, the second region may include a conical surface in which a vertex is disposed on a central axis of the bottom section.

Further, according to a fifth aspect, in any one of the first aspect and the second aspect, the second region may include a spherical surface centered on the central axis of the bottom section.

Further, according to a sixth aspect, in any one of the first to fifth aspects, the disc brake piston further includes a plurality of protruding portions protruding to an opposite side to an opening section in the axial direction, on the outer bottom surface of the bottom section.

Further, in a seventh aspect, a disc brake including the piston according to any one of the first to fifth aspects is considered. According to the seventh aspect, the reliability is improved by enhancing the strength of the piston, and the suppression of the weight increase of the piston leads to suppression of the overall weight increase.

It is needless to say that the aforementioned piston is not limited to the disc brake of FIG. 1, but can also be applied to a fixed caliper type (opposed piston type), a two-piston type floating caliper type, or the like.

### INDUSTRIAL APPLICABILITY

According to the above piston and the disc brake using the same, it is possible to achieve high strength while suppressing the weight increase.

### REFERENCE SIGNS LIST

10, 10A 10B 10C Piston
11 Disc brake
51 Opening section
52 Piston wall section (wall section)
53, 53A, 53B Piston bottom section (bottom section)
71 First region
72 Second region
72A, 72B Second region (variable thickness region)
102 First constant-thickness region (constant-thickness region)
103 Second variable thickness region (variable thickness region)

1. A disc brake piston comprising:
a tubular wall section having an opening section at one end in an axial direction; and
a bottom section configured to close the other end of the wall section in the axial direction,
wherein the bottom section comprises:
a first annular region provided on an inner side of the wall section in a radial direction to be continuous with the wall section; and
a second region provided on the inner side of the first region in the radial direction and formed in a recessed shape in the axial direction, and
wherein the second region has a variable thickness region in which a thickness in the axial direction becomes thinner toward the inner side in the radial direction.

2. The disc brake piston according to claim 1, wherein the first region has a constant-thickness region in which a thickness in the axial direction is constant irrespective of a position in the radial direction.

3. The disc brake piston according to claim 1, wherein the second region comprises a third region on the radially inner side in which the thickness in the axial direction is constant irrespective of the position in the radial direction.

4. The disc brake piston according to claim 1, wherein the second region comprises a conical surface in which a vertex is disposed on a central axis of the bottom section.

5. The disc brake piston according to claim 1, wherein the second region comprises a spherical surface centered on a central axis of the bottom section.

6. The disc brake piston according to claim 1, further comprising:
a plurality of protruding portions protruding to an opposite side to the opening section in the axial direction, on the outer bottom surface of the bottom section.

7. A disc brake comprising the piston according to claim 1.
